(19) United States
(12) Patent Application Publication
(10) Pub. No.: US 2015/0055329 A1
(43) Pub. Date: Feb. 26, 2015

(54) ENERGY EFFICIENT ILLUMINATABLE HOUSEHOLD NUMBERING ARRANGEMENT

(71) Applicant: TRIO GROUP AUSTRALIA PTY. LTD., Kilburn (AU)

(72) Inventor: Peter Demourtzidis, Kilburn (AU)

(21) Appl. No.: 13/970,682

(22) Filed: Aug. 20, 2013

(51) Int. Cl. F21S 8/00; G09F 13/04; F21V 33/00

(52) U.S. Cl. CPC F21S 8/036; F21V 33/006; G09F 13/04
USPC 362/183

(57) ABSTRACT

An energy efficient illuminatable household number arrangement having at least one main housing block with a defined cut-out that represents a digit to be illuminated, an illuminatable backing plate pressed up against the defined cut-out, a solar panel positionable upon the main housing block that energises an illuminatable device that illuminates the illuminatable backing plate, a bracket adapted to be mounted upon a wall adapted to slidably receive and nest therein the or each main housing block such that when in use one or more main housing blocks with defined cut-out representing a household number are enclosed within said bracket to be mounted to represent the street number of the respective household.

### TECHNOLOGICAL FIELD

This invention relates to a household numbering arrangement and more particularly to an improved way of providing energy efficient illuminatable digits that correspond to a household number.

### BACKGROUND ART DISCUSSION

In the past lighting arrangements have been incorporated with numbers so as to make the household and related buildings identifiable with their appropriate numbered street address, particularly during those times outside of the daylight hours.

However as there are so many different potential household numbers that need to be incorporated into an illuminated household numbering arrangement makes it difficult to come up with some type of universal numbering system that could provide what could best be described as one arrangement fits all.

One example of a conventional single arrangement that fits all potential household numbering requirements involves an embodiment that for the most part includes a main illuminated housing block to which on the illuminated surface labels or stickers of the required numbers and/or letters are then stuck on to the illuminatable face.

The problem with such an arrangement is that the illuminated surface is at least partially covered by the label or sticker that has been placed upon it. As is to be expected the number is to be identified by the difference in brightness between the illuminated surface and the darkness of the label or sticker that has been attached to the front of the illuminatable device.

Therefore energy is wasted in that greater illumination is required if adequate brightness differentiation is going to be achieved between the illuminated plate and the labels and stickers that are attached thereon to represent the household number.

Still further when such arrangements are mounted on an external wall or door to represent the household number, tampering by a passers-by is always a potential risk in that the labels and/or stickers can be easily removed, damaged and/or reconfigured creating temporary havoc for those seeking the correct address details of a particular household.

Therefore it would be particularly advantageous if it was possible to provide an illuminatable household numbering arrangement wherein the numbering system placed or presented upon the main housing block did not detract from the brightness established by the energised illumination.

It would also be particularly advantageous to be able to provide not only an energy efficient illuminatable household numbering arrangement but also one that offers a degree of defence against unauthorised tampering and adjustment to the numbers represented within the arrangement.

Accordingly an object of this invention is to provide an energy efficient illuminatable household numbering arrangement that is adapted to overcome the shortcomings of at least some of the problems referred to above or in the very least provide an improved arrangement with which households will be able to have their respective street number illuminated with energy efficiency and greater illumination than would otherwise be expected to improve visibility particularly outside those daylight hours.

Further objects and advantages of the invention will become more apparent from a complete reading of the following specification.

### SUMMARY OF THE INVENTION

In one embodiment of the invention there is provided an energy efficient illuminatable household number arrangement, said arrangement including;

at least one main housing block having a front face including a defined cut-out wherein the defined cut-out represents a configuration of a digit to be illuminated, said main housing block further including an illuminatable backing plate pressed up against said defined cut-out on the front face of the main housing block;

a solar panel positionable with the main housing block, said solar panel adapted to either partially or completely energise an illuminatable device either directly or indirectly wherein said illuminated device is enclosed within the main housing block and when energised illuminates the illuminatable backing plate pressed up against said defined cut-out on the front face of said main housing block;

a bracket adapted to be mounted upon a wall and/or door, said bracket having a substantially C shaped cross section with laterally extended top and bottom skirts, said top and bottom skirts adapted to slidably receive and nest therein the or each main housing block, said bracket further including two opposing end members adapted to enclose the or each main housing block within said bracket;

such that when in use one or more main housing blocks with defined cut-out representing a household number are enclosed within said bracket to be mounted upon a wall and/or door of a respective household.

In preference corresponding fastening holes are provided on the side and/or top and/or bottom of the main housing block configured to correspond with matching holes included as part of either or both end members of said bracket arrangement and/or the holes included as part of the top and/or bottom skirts of said bracket arrangement such that when the respective holes of the main housing block are aligned with corresponding holes of the bracket arrangement fastening screws, rivets and bolts are adapted to securely fix said main housing block within the bracket arrangement.

In preference the bracket arrangement includes a breadth to enclose a single main housing block or a breadth to enclose two main housing blocks or a breadth to enclose three main housing blocks.

In preference wherein the household number requires four or more numbers and/or letters to be represented, a combination of single, double or triple accommodating bracket arrangements are used in combination to match the requisite number wherein brackets arrangements can be joined together in a mounted position by removing the end members of the respective bracket arrangement of the joining ends of the bracket arrangements being joined together.

In preference the solar panel is included on the front face of the main housing block above the defined cut-out, wherein the solar panel is attached to the front face with a slightly inwardly directed incline.

Advantageously this invention provides for a unique energy efficient illuminatable household numbering arrangement that is able to utilise solar energy in order to energise an illuminating device which is able to represent a digit that has been cut-out within the main housing block.

As the digit is defined by way of a defined cut-out rather than a label or sticker it does not reduce or cover up the illuminated backing plate.

The important part, that being the actual digit itself is illuminated rather than in conventional arrangements where it is the areas surrounding the digit that becomes illuminated.

By combining the main housing block which defines the digit that represents the household number with the bracket arrangement gives an easy means in which one can select the number or numbers required, slide them into place within the corresponding bracket to be fixed then to the wall or door as required.

The use of additional fastening holes which have been symmetrically configured to line up when the main housing block and the bracket arrangement further enhances the degree of security and means to prevent any unauthorised tampering to the illuminatable number representation.

In an alternative embodiment the solar panel is attached to an extension lead connected to the main housing block.

An advantage of such an arrangement is that in places where there is poor sunlight interaction the lead can be used to position the solar panels at a distance from the main housing block so as to better capture available sunlight.

In order now to describe the invention in greater detail a series of illustrations and accompanying text will be used to present preferred embodiments of the invention.

### BRIEF DESCRIPTION OF THE DRAWINGS

FIG. 1 is a front view of the main housing block that includes the defined cut-out of the configuration of the digit to be illuminated as well as enclosing the illuminatable device powered by the solar panel.

FIG. 2 is a cross-section side view of FIG. 1.

FIG. 3 is an exploded perspective view of the bracket arrangement adapted to enclose the or each main housing block the kinds of which is illustrated in FIG. 1.

FIG. 4 is a part exploded perspective view showing a main housing block being enclosed within a bracket arrangement adapted to accommodate a single housing block.

FIG. 5 is a schematic representation of the illuminated household number arrangement of the invention in a preferred embodiment of the invention being mounted to a wall.

### DETAILED DESCRIPTION OF THE INVENTION

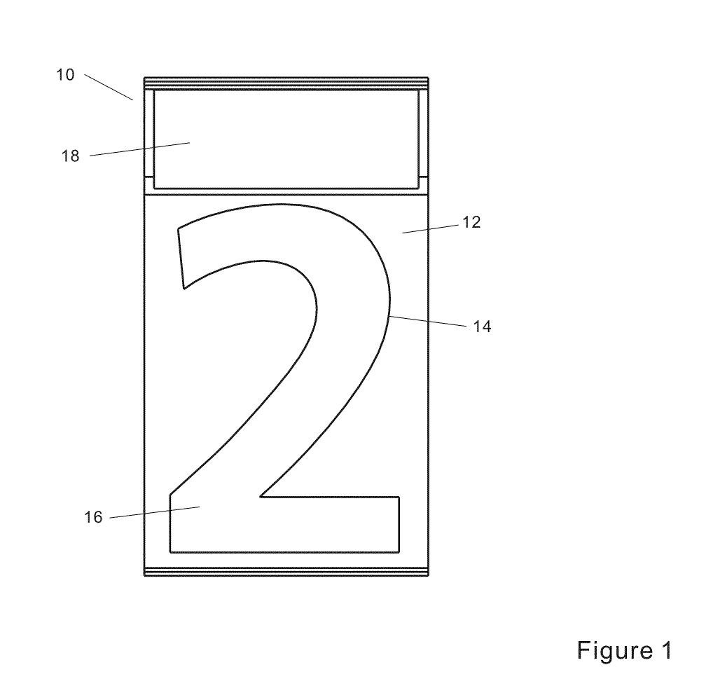

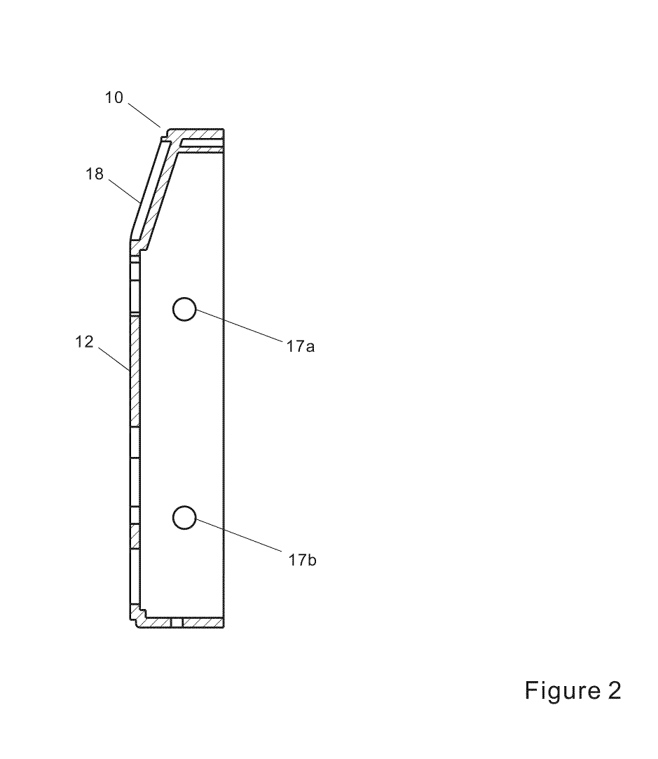

Referring to the drawings now in greater detail wherein FIG. 1 is shown as a front view of a main housing block, and FIG. 2 as a side cross-section view of FIG. 1, with the main housing block shown generally as (10).

The main housing block includes a front face (12) which includes the defined cut-out (14), which in the embodiment illustrated in FIG. 1 is for the letter B.

An illuminatable backing plate (16) is pressed up against the defined cut-out (14).

Albeit not shown in the illustrations the main housing block would enclose the illuminatable device which is charged at least partially by the solar panel.

Albeit again as not illustrated the main housing block would also enclose all the relevant electronic and electrical circuitry required in order to utilise the harnessed solar energy from the solar panel for energizing the illumination device at the back of illuminatable backing plate.

In some embodiments the main housing block would also include a rechargeable battery in combination with the solar panel wherein the rechargeable battery is adapted to energise the illuminatable device enclosed within the main housing block.

What is significant to the invention is that the illuminatable backing plate is pressed up against the defined cut-out (14) which represents the configuration of the digit which corresponds to the household number or part thereof.

Unlike a conventional arrangement wherein a label or sticker of the number would cover over the illuminatable backing plate, the opposite situation is uniquely presented in this invention wherein the defined cut-out (14) actually exposes the illuminatable backing plate (16) thereby maximizing the benefits of the light created by the illuminating device withinside the main housing block.

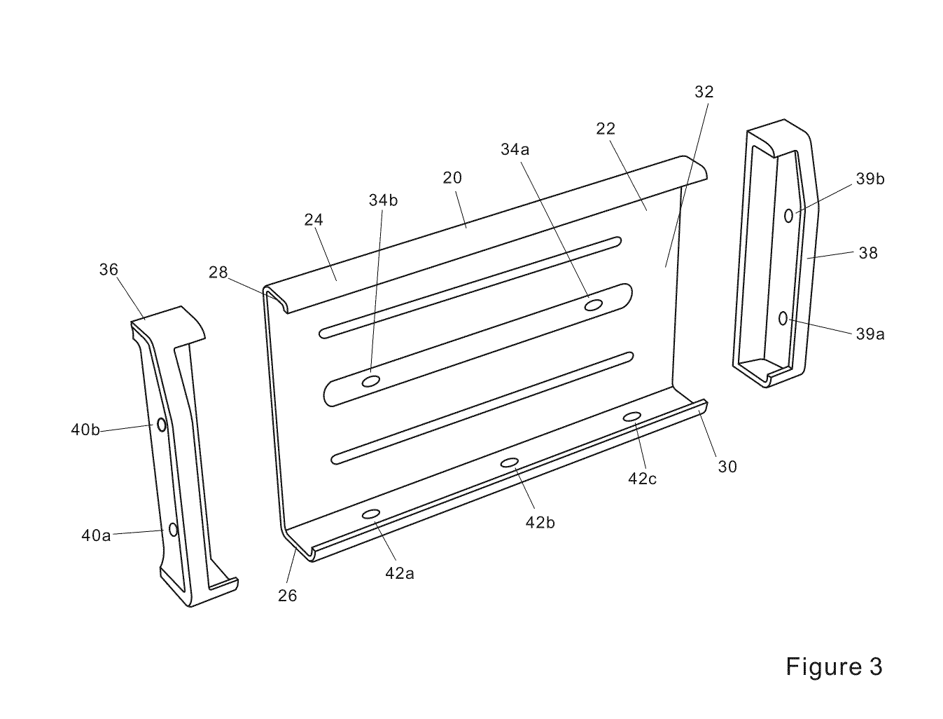

FIG. 3 represents an embodiment of the bracket arrangement which is able to enclose the main housing block (10) referred to in FIGS. 1 and FIG. 2.

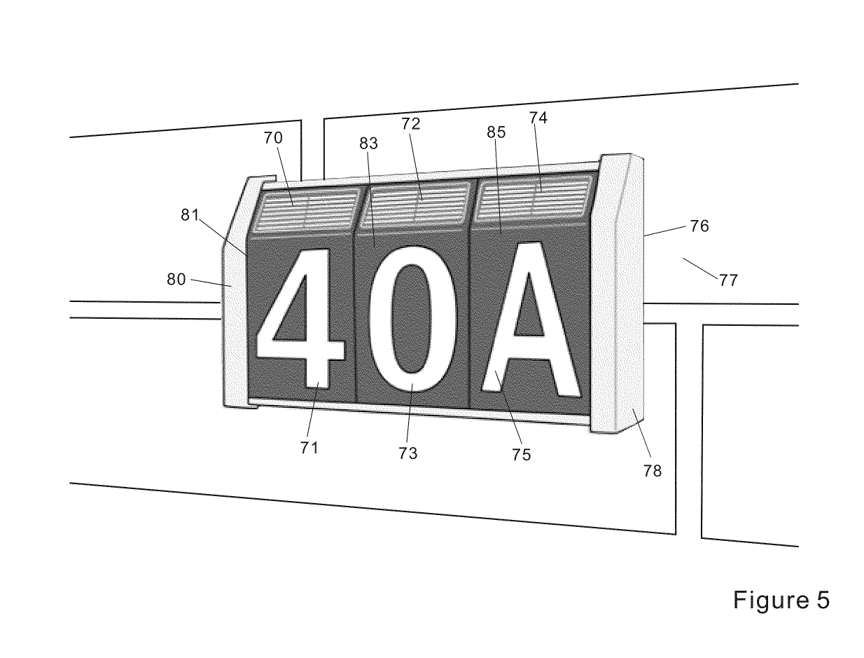

In FIG. 3 the bracket arrangement shown generally as (20) is able to accommodate three main housing blocks and which will be described in greater detail when referencing FIG. 5 corresponds therefore to a household number arrangement that has three digits.

The bracket arrangement (20) has a substantially C shaped cross section configuration with a main mountable back plate (32) with laterally extended top and bottom skirts (24), (26).

As illustrated by numbers (28) and (30) both the top and bottom skirts (24), (26) have rounded shouldered edges (28), (30) so as to for the most part contour the shape of a main housing block as it is slideably engaged within the bracket arrangement (20) to be rested therein.

The bracket arrangement also includes end members (36) and (38) which have internal contoured shape to frictionally fit at the respective ends of the main mountable back plate (32).

Mounting holes (34a) and (34b) allow the bracket to be mounted upon a wall and/or a door.

As is to be appreciated once the open ended bracket (22) has been mounted upon a wall the or each main housing block can then be slid into the main body part of the bracket and once enclosed can then be closed off and encapsulated by clamping the two ends (36) and (38) of the bracket arrangement (22) to the main mountable back plate (32) of the bracket.

Holes (40a) and (40b) on end member (36) and holes (39a) and (39b) on end member (38) along with holes (42a), (42b) and (42c) on the bottom skirt (26) of the main mountable back plate (32) of the bracket arrangement (20) are configured so as to align with corresponding holes of the main housing blocks that are to be nested therein the bracket arrangement so as to fixedly engage the housing blocks to the bracket arrangement (20).

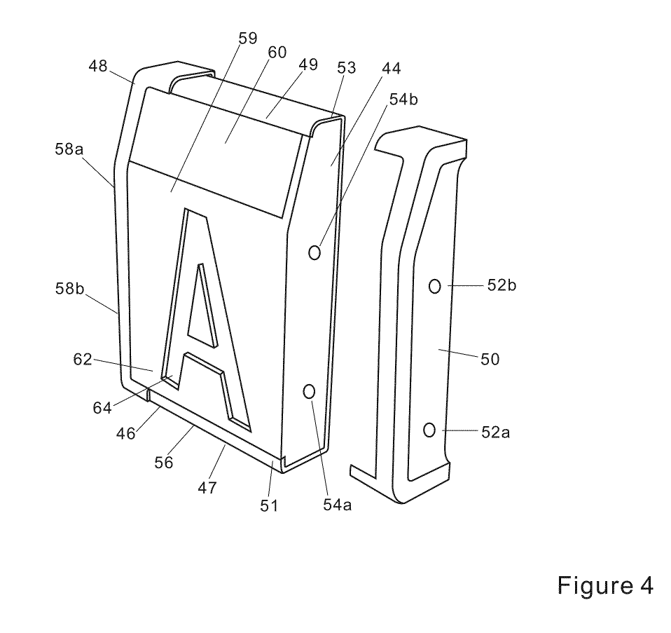

FIG. 4 shows a main housing block (44) rested in a bracket arrangement (46) that is adapted to accommodate just a single housing block.

The housing block (44) has been able to slide in and be enclosed by the top and bottom skirts (46) and (49) of the bracket (46) and the shouldered edges (51) and (53) the solar panel (60) of the main housing block (44) is presented on the top surface (59) of the housing block (44) at a slight incline.

As with other embodiments, the main housing block (44) includes the defined cut-out (62) which represents the digit for the required household number and wherein the illuminatable backing plate (64) is pressed up against the defined cut-out (62).

Holes (52a) and (52b) on end member (50) correspond with holes (54a) and (54b) on the main housing block and so too corresponding holes (58a) and (58b) of the end member (48) of the bracket arrangement (56) which allows the main housing block (44) to be fastened to the bracket arrangement (46). Hole (56) on the bottom skirt (47) of the bracket (46) also provides an additional point to secure the main housing block withinside the bracket (46).

FIG. 5 shows the illuminatable household numbering arrangement (76) being mounted to a wall (77).

A bracket arrangement (79) with its two end members (78) and (80) are able to secure in place three separate main housing blocks (70), (72) and (74) each with their own defined cut-out (81), (83) and (85) representing the digits for the household number which in this instance correlates to “40A”.

The respective defined cut-outs (81), (83) and (85) provide a mechanism wherein the illuminated backing plates (71), (73) and (75) are able to illuminate the defined cut-out of the represented configuration of the digit that corresponds with the required number for the household street number.

The claims defining the invention are as follows:

1. An energy efficient illuminatable household number arrangement, said arrangement including;
at least one main housing block having a front face including a defined cut-out wherein the defined cut-out represents a configuration of a digit to be illuminated, said main housing block further including an illuminatable backing plate pressed up against said defined cut-out on the front face of the main housing block;
a solar panel positionable with the main housing block, said solar panel adapted to either partially or completely energise an illuminatable device either directly or indirectly wherein said illuminated device is enclosed within the main housing block and when energised illuminates the illuminatable backing plate pressed up against said defined cut-out on the front face of said main housing block;
a bracket adapted to be mounted upon a wall and/or door, said bracket having a substantially C shaped cross section with laterally extended top and bottom skirts, said top and bottom skirts adapted to slidably receive and nest therein the or each main housing block, said bracket further including two opposing end members adapted to enclose the or each main housing block within said bracket;
such that when in use one or more main housing blocks with defined cut-out representing a household number are enclosed within said bracket to be mounted upon a wall and/or door of a respective household.

2. The energy efficient illuminatable household number arrangement of claim 1 further including corresponding fastening holes are provided on the side and/or top and/or bottom of the main housing block configured to correspond with matching holes included as part of either or both end members of said bracket arrangement and/or the holes included as part of the top and/or bottom skirts of said bracket arrangement such that when the respective holes of the main housing block are aligned with corresponding holes of the bracket arrangement fastening screws, rivets and bolts are adapted to securely fix said main housing block within the bracket arrangement.

3. The energy efficient illuminatable household number arrangement of claim 1 wherein the bracket arrangement includes a breadth to enclose a single main housing block or a breadth to enclose two main housing blocks or a breadth to enclose three main housing blocks.

4. The energy efficient illuminatable household number arrangement of claim 3 wherein the household number requires four or more numbers and/or letters to be represented, a combination of single, double or triple accommodating bracket arrangements are used in combination to match the requisite number wherein brackets arrangements can be joined together in a mounted position by removing the end members of the respective bracket arrangement of the joining ends of the bracket arrangements being joined together.

5. The energy efficient illuminatable household number arrangement of claim 1 wherein the solar panel is included on the front face of the main housing block above the defined cut-out, wherein the solar panel is attached to the front face with a slightly inwardly directed incline or the solar panel is attached to an electrical extension lead, wherein the electrical extension lead is connected to the main housing block.
